(19) United States
(12) Patent Application Publication
(10) Pub. No.: US 2003/0132009 A1
(43) Pub. Date: Jul. 17, 2003

(54) Method of fighting a smouldering attic fire with a piercing nozzle and a piercing nozzle

(76) Inventor: Brian D. Thompson, St. Albert (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/346,303

(22) Filed: Jan. 16, 2003

(30) Foreign Application Priority Data
Jan. 17, 2002 (CA) 2,368,399

(51) Int. Cl. A62C 2/00

(52) U.S. Cl. 169/46

(57) ABSTRACT

A method of fighting a smouldering attic fire with a piercing nozzle. A first step involves piercing a ceiling with a piercing nozzle to provide access to a fire in an attic insulated with insulation. The piercing nozzle is equipped with a diffuser. A second step involves diffusing small amounts of water delivered from a pressurized cylinder through the diffuser on the piercing nozzle into the insulation and relying upon the heat of the fire to convert the water to steam. The rapid expansion of the steam extinguishes the smouldering fire.

### FIELD OF THE INVENTION

The present invention relates to a method of fighting a smouldering attic fire with a piercing nozzle and a piercing nozzle developed for the purpose of fighting such a fire.

### BACKGROUND OF THE INVENTION

When faced with a smouldering fire in an attic, fire fighters formerly would open the ceiling to provide better access to fight the fire. The smouldering fire would burst into flames when exposed to oxygen. By applying copious amounts of water, fire fighters were able to extinguish the fire.

In order to fight fires more effectively, piercing nozzles were developed. Examples of piercing nozzles include: U.S. Pat. No. 4,697,740; U.S. Pat. No. 4,809,535; CA 2,030,025; CA 2,058,919; and U.S. Pat. No. 5,649,599. The piercing nozzle enabled water to be applied to the fire, prior to opening the ceiling.

It has been determined, however, that the water stream produced by piercing nozzles tends to blow smouldering cellulose insulation around the attic and initially spreads the fire. A ceiling fire in an attic insulated with cellulose insulation is, therefore, taking more time and much greater volumes of water to extinguish. This is creating extensive damage.

### SUMMARY OF THE INVENTION

What is required is a method of fighting a smouldering attic fire with a piercing nozzle and a piercing nozzle that has been constructed in accordance with the teachings of the method.

According to one aspect of the present invention there is provided a method of fighting a fire with a piercing nozzle. A first step involves piercing a ceiling with a piercing nozzle to provide access to a fire in an attic insulated with insulation. The piercing nozzle is equipped with a diffuser. A second step involves diffusing small amounts of water delivered from a pressurized cylinder through the diffuser on the piercing nozzle into the insulation and relying upon the heat of the fire to convert the water to steam. The rapid expansion of the steam extinguishes the smouldering fire.

The method, as described above, involves a paradigm shift in thinking. According to the teaching of this method, it is not desirable to fight a smouldering fire with water. The intention is to fight the fire with steam. When heated, steam expands to approximately 1700 times its original volume. When super heated, steam is capable of expanding even more.

According to another aspect of the present invention there is provided a piercing nozzle which has been developed for fighting fires with steam, rather than streams of water. This piercing nozzle includes a body having an orifice with an inlet end and an outlet end. A rigid piercing frame overlies the outlet end of the orifice. A diffuser is secured to the frame in spaced relation to the outlet end of the orifice. The diffuser diffuses water exiting the outlet end of the orifice.

When the piercing nozzle, as described above, is used the water stream passing through the nozzle is diffused so that it does not tend to move cellulose insulation around the attic spreading the fire.

Although beneficial results may be obtained through the use of the piercing nozzle, as described above, even more beneficial results may be obtained when there are several sequential diffuser plates. All but the last of the diffuser plates have a flow through orifice thereby permitting water to pass from one diffuser plate to the next diffuser plate of the several sequential diffuser plates. It is preferred that the flow through orifice of each of the sequential diffuser plates is progressively smaller.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a piercing nozzle constructed in accordance with the teachings of the present invention.

FIG. 2 is a side elevation view of a fire in an attic being fought using the piercing nozzle in accordance with the teachings of the method of fighting a fire with a piercing nozzle.

### DETAILED DESCRIPTION OF THE PREFERRED EMBODIMENT

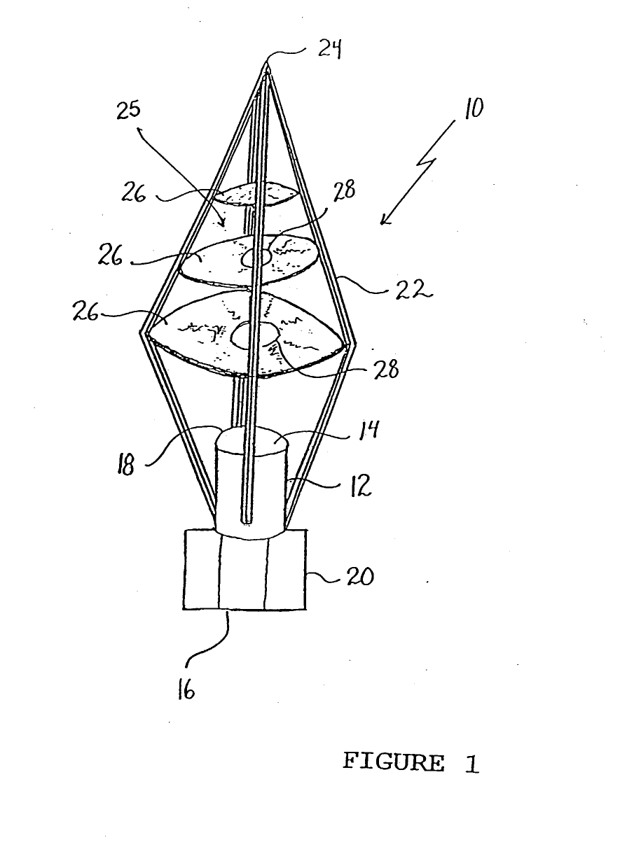

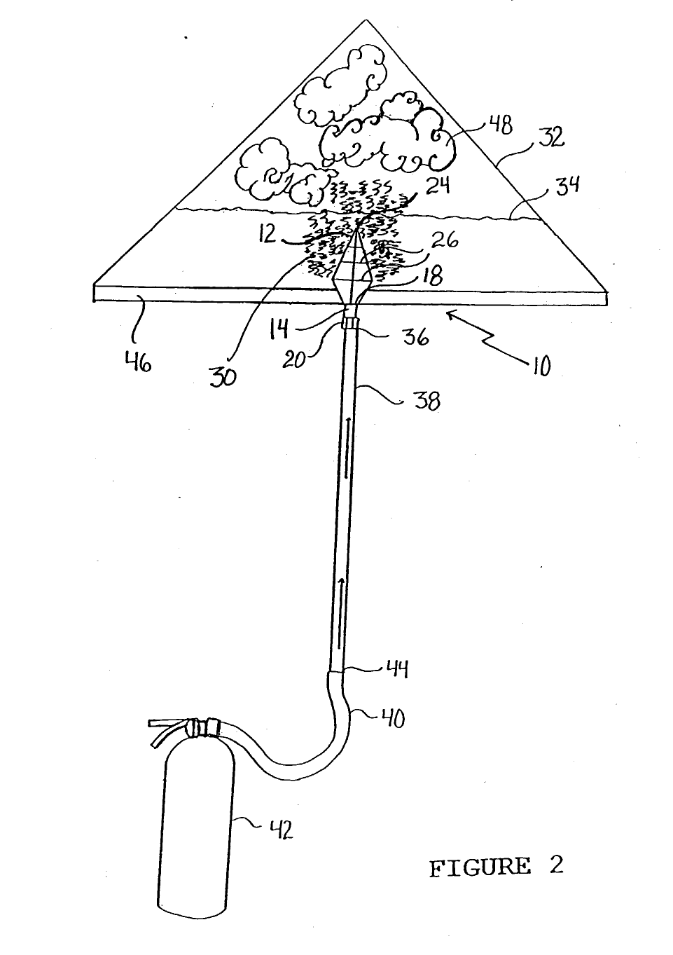

The preferred embodiment, a piercing nozzle generally identified by reference numeral 10, will now be described with reference to FIGS. 1 through 2.

### Structure and Relationship of Parts:

Referring to FIG. 1, piercing nozzle 10 includes a body 12 having an orifice 14 with an inlet end 16 and an outlet end 18. A connector 20 is provided at inlet end 16. A rigid piercing frame 22 overlies outlet end 18 of orifice 14. Rigid piercing frame 22 has a sharp piercing tip 24. A diffuser, generally indicated by reference numeral 25, is provided which consists of several sequential diffuser plates 26 secured to frame 22 in spaced relation to outlet end 18 of orifice 14. As will hereinafter be further described, the sequential diffuser plates 26 diffuse water exiting outlet end 18 of orifice 14. All but the last of plates 26 have a flow through orifice 28 thereby permitting water to pass from one diffuser plate 26 to next diffuser plate 26 of sequential diffuser plates 26. Flow through orifice 28 of each sequential diffuser plate 26 becomes progressively smaller.

### Operation:

The use and operation of piercing nozzle 10 will now be described with reference to FIGS. 1 and 2. Referring to FIG. 2, there is illustrated a smouldering fire 30 in an attic 32 which has been insulated with cellulose insulation 34. Piercing nozzle 10, as described above, is provided. Connector 20 of piercing nozzle 10 is used to secure piercing nozzle 10 to a first end 36 of a hollow rigid shaft 38. It is preferred that rigid shaft 38 be insulated to protect fire fighters from experiencing electrical shock during use. A flexible hose 40 extends from a pressurized cylinder 42 and is secured to second end 44 of hollow shaft 38.

Rigid hollow shaft 38 is used to push piercing nozzle 10, so that piercing tip 24 of rigid piercing frame 22 pierces a ceiling 46 to provide access to fire 30 in insulated attic 32. Piercing nozzle is preferably positioned straight into the seat of the heat within the smouldering cellulose insulation 34 in attic 32. Small amounts of water delivered from pressurized cylinder 42 are then allowed to flow at low pressure through flexible hose 40, up through hollow shaft 38 and through orifice 14 of piercing nozzle 10. Referring to FIG. 1, sequential diffuser plates 26 diffuse water exiting outlet end 18 of orifice 14 into smouldering cellulose insulation 34. Water passes strikes each diffuser plate 26 sequentially. At each diffuser plate 26, a portion of the water is diffused and a portion of the water passes through orifice 28 from one diffuser plate 26 to next diffuser plate 26. Water continues to pass though orifice 28 of each sequential diffuser plate 26 until the last and smallest of diffuser plates 26 is encountered that does not have an orifice 28. Referring to FIG. 2, heat from fire 30 converts water to steam 48, and with the rapid expansion of steam 48, roughly 1700 times, smouldering fire 30 is extinguished. It will be apparent to one skilled in that art that the above described method enables a fire to be extinguished with a minimum of water damage.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1. A method of fighting a smouldering attic fire with a piercing nozzle, comprising the steps of:
piercing a ceiling with a piercing nozzle to provide access to a fire in an attic insulated with insulation, the piercing nozzle being equipped with a diffuser; and
diffusing small amounts of water delivered from a pressurized cylinder through the diffuser on the piercing nozzle into the insulation and relying upon the heat of the fire to convert the water to steam, with the rapid expansion of the steam extinguishing the fire.

2. A piercing nozzle, comprising:
a body having an orifice with an inlet end and an outlet end;
a rigid piercing frame overlying the outlet end of the orifice;
a diffuser secured to the frame in spaced relation to the outlet end of the orifice, such that the diffuser diffuses water exiting the outlet end of the orifice.

3. The piercing nozzle as defined in claim 2, wherein the diffuser includes at least one diffuser plate.

4. The piercing nozzle as defined in claim 3, wherein there are several sequential diffuser plates, all but the last of which have a flow through orifice thereby permitting water to pass from one diffuser plate to the next diffuser plate of the several sequential diffuser plates.

5. The piercing nozzle as defined in claim 4, wherein the flow through orifice of each of the sequential diffuser plates becomes progressively smaller.

6. A piercing nozzle, comprising:
a body having an orifice with an inlet end and an outlet end;
a rigid piercing frame overlying the outlet end of the orifice;
several sequential diffuser plates secured to the frame in spaced relation to the outlet end of the orifice, such that the several sequential diffuser plates diffuse water exiting the outlet end of the orifice, all but the last of which have a flow through orifice thereby permitting water to pass from one diffuser plate to the next diffuser plate of the several sequential diffuser plates, the flow through orifice of each of the sequential diffuser plates becomes progressively smaller.
